(19) United States
(12) Patent Application Publication
(10) Pub. No.: US 2021/0287096 A1
(43) Pub. Date: Sep. 16, 2021

(54) MICROTRAINING FOR ITERATIVE FEW-SHOT REFINEMENT OF A NEURAL NETWORK

(71) Applicant: NVIDIA Corporation, Santa Clara, CA (US)

(72) Inventors: Anjul Patney, Kirkland, WA (US); Brandon Lee Rowlett, Cedar Park, TX (US); Yinghao Xu, San Jose, CA (US); Andrew Leighton Edelsten, Morgan Hill, CA (US); Aaron Eliot Lefohn, Kirkland, WA (US)

(21) Appl. No.: 16/818,266

(22) Filed: Mar. 13, 2020

(51) Int. Cl. G06N 3/08; G06N 5/04; G06N 20/00; G06T 5/00; G06T 5/50; G06T 7/00

(52) U.S. Cl. CPC G06N 3/084; G06N 5/046; G06N 20/00; G06T 5/001; G06T 2207/30201; G06T 7/0012; G06T 2207/20084; G06T 2207/20081; G06T 5/50

(57) ABSTRACT

The disclosed microtraining techniques improve accuracy of trained neural networks by performing iterative refinement at low learning rates using a relatively short series microtraining steps. A neural network training framework receives the trained neural network along with a second training dataset and set of hyperparameters. The neural network training framework produces a microtrained neural network by adjusting one or more weights of the trained neural network using a lower learning rate to facilitate incremental accuracy improvements without substantially altering the computational structure of the trained neural network. The microtrained neural network may be assessed for changes in accuracy and/or quality. Additional microtraining sessions may be performed on the microtrained neural network to further improve accuracy or quality.

### TECHNICAL FIELD

The present disclosure relates to neural network training, and more specifically to microtraining for iterative few-shot refinement of a neural network.

### BACKGROUND

Conventional neural network training techniques sometimes produce inadequate results with respect to accuracy or quality. This is especially the case when training is based on datasets that may be insufficient, biased, or a combination thereof. Furthermore, conventional training techniques generally fail to provide additional improvement opportunities in constrained scenarios where inaccurate training loss or insufficient data make retraining impractical or ineffective. In generative neural network image synthesis applications, inadequate results may be evident in the form of image artifacts in a generated image. There is a need for addressing these issues and/or other issues associated with the prior art.

### SUMMARY

A method, computer readable medium, and system are disclosed for microtraining a neural network to improve accuracy and/or quality. The method comprises receiving a neural network trained to satisfy a loss function using a first set of hyperparameters and a first training dataset, receiving a second training dataset, and receiving a second set of hyperparameters. In an embodiment, a second learning parameter specified in the second set of hyperparameters limits adjustments of one or more weights used by the neural network compared with a corresponding first learning parameter in the first set of hyperparameters. The method further comprises applying the second training dataset to the neural network according to the second set of hyperparameters to produce a first microtrained neural network by adjusting the one or more weights used by the neural network to process the second training dataset. In certain applications, the trained neural network generates output data including visual artifacts; and, the first microtrained neural network produced according to the method reduces the visual artifacts.

### BRIEF DESCRIPTION OF THE DRAWINGS

FIG. 1A illustrates a flowchart of a method for microtraining a neural network, in accordance with an embodiment.

FIG. 1B illustrates microtraining within an overall hypothesis space, in accordance with an embodiment.

FIG. 1C illustrates a neural network framework, in accordance with an embodiment.

FIG. 2A illustrates a flowchart of a method for improving neural network training using microtraining, in accordance with an embodiment.

FIG. 2B illustrates a plot of average differences between layers of various microtrained networks, in accordance with an embodiment.

FIG. 3 illustrates a parallel processing unit, in accordance with an embodiment.

FIG. 4A illustrates a general processing cluster within the parallel processing unit of FIG. 3, in accordance with an embodiment.

FIG. 4B illustrates a memory partition unit of the parallel processing unit of FIG. 3, in accordance with an embodiment.

FIG. 5A illustrates the streaming multi-processor of FIG. 4A, in accordance with an embodiment.

FIG. 5B is a conceptual diagram of a processing system implemented using the PPU of FIG. 3, in accordance with an embodiment.

FIG. 5C illustrates an exemplary system in which the various architecture and/or functionality of the various previous embodiments may be implemented.

### DETAILED DESCRIPTION

The disclosed techniques, referred to herein as microtraining, improve accuracy of trained neural networks by performing iterative refinement at low learning rates using a series of few-shot microtraining steps. The microtraining steps include significantly fewer training iterations than initial training of a trained neural network. A lower learning rate in this context facilitates incrementally improving accuracy without substantially altering the computational structure of the trained neural network. In this context, the computational structure refers to both neural network topology and various distributions represented internally therein (e.g., by activation weights, activation functions, etc.). A given network topology may specify how internal artificial neuron nodes are organized into layers and connected to each other. Each microtraining step may be followed by an evaluation step (e.g., input from a human operator through a user interface) to assess an incremental quality change. For example, a small number of pixels associated with thin lines (e.g. dark telephone wires against a light sky in an outdoors scene) may exhibit aliasing artifacts visible to the human operator (viewer) that are largely ignored by conventional automated training; however, those pixels may be optimized during microtraining to appear properly antialiased. In this context, microtraining refines a previously trained network to reduce or eliminate such visually important artifacts (e.g. aliasing).

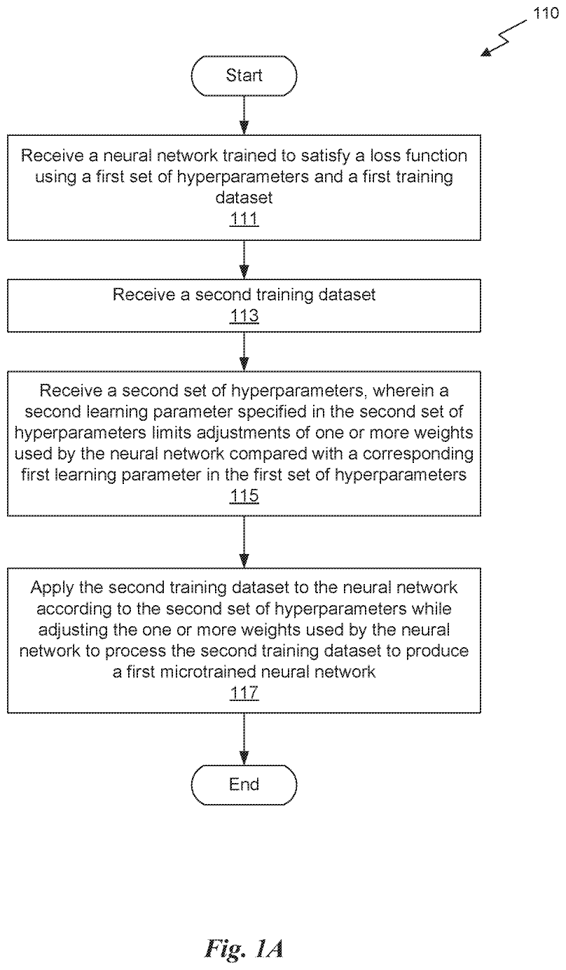

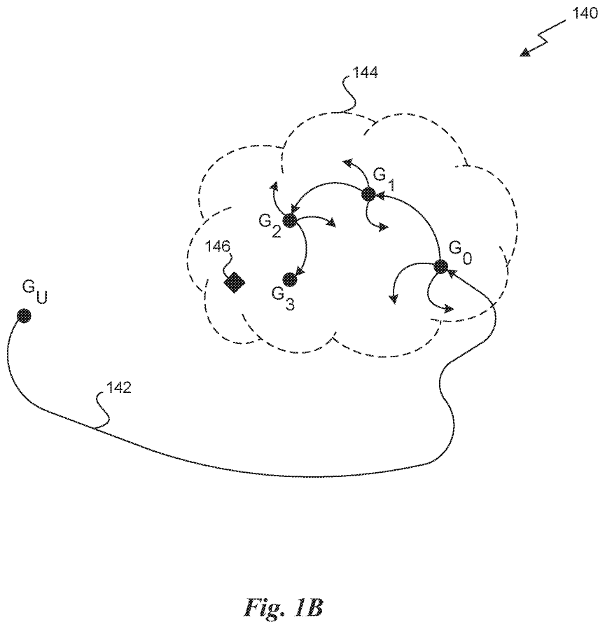

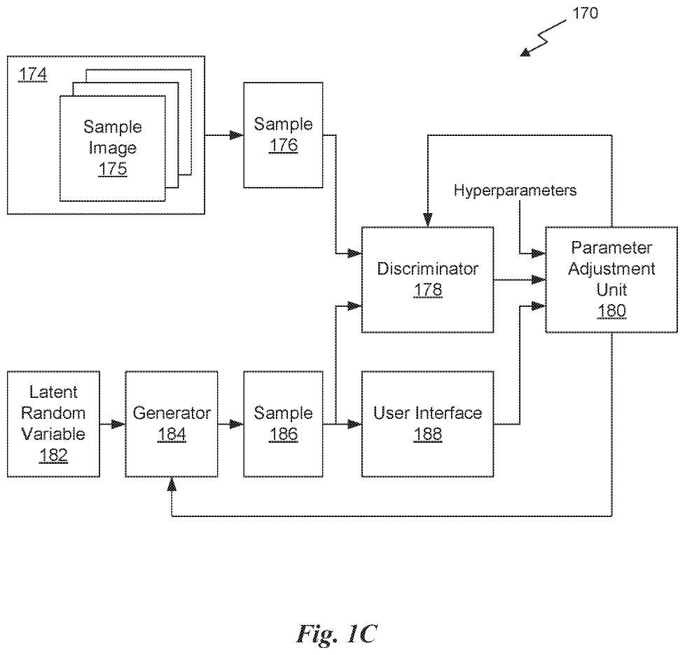

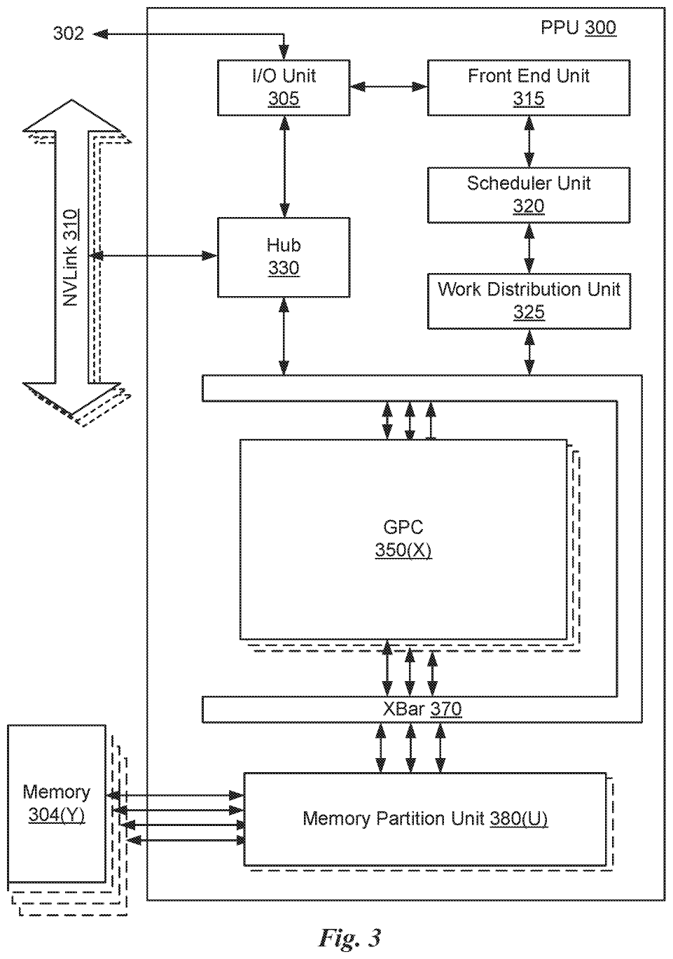

FIG. 1A illustrates a flowchart of a method 110 for microtraining a neural network, in accordance with an embodiment. Although method 110 is described in the context of a processing unit, the method 110 may also be performed by a program, custom circuitry, or by a combination of custom circuitry and a program. For example, the method 110 may be executed by a GPU (graphics processing unit), CPU (central processing unit), or any processor capable of performing operations for evaluating and training neural networks. Furthermore, persons of ordinary skill in the art will understand that any system that performs method 110 is within the scope and spirit of embodiments of the present disclosure. In an embodiment, a processing unit performs method 110 in conjunction with various operations of a neural network training framework and/or a neural network runtime system. In certain embodiments, the processing unit includes one or more instances of a parallel processing unit, such as parallel processing unit 300 of FIG. 3.

Method 110 begins at step 111, where the processing unit receives a neural network (G_{S}) trained to satisfy a loss function (L_{S}) using a first set of hyperparameters (H_{S}) and a first training dataset (D_{S}). In an embodiment, the neural network is a deep generative neural network configured to generate images. In an embodiment, the first set of hyperparameters includes at least one model scale parameter such as an epoch count, a batch size, a training iteration count, a learning rate, and a loss function. In an embodiment, the epoch count specifies a number of training passes over all specified training samples. Each training pass on a given training sample includes one forward pass and one backward pass. The specified training samples may be organized into batches, with the batch size specifying a number of training samples per batch. The training iteration count specifies a number of training passes conducted on the different batches to train a given neural network on all available training samples once. For example, with one thousand training samples and a batch size of two hundred, five iterations are required to complete one epoch. In an embodiment, a given set of hyperparameters may reference one or more collections of training samples. Furthermore, the learning rate is a value that scales how fast a given neural network adjusts weights in a given pass. Additionally, the loss function may specify a difference between a predicted output and an actual output computed by the neural network. In the context of a hyperparameter, the loss function may specify a function for computing the difference.

In certain usage cases, the neural network (G_{S}) is trained to generate new images by optimizing the loss function (L_{S}) using the first set of hyperparameters (H_{S}) and the first training dataset (D_{S}). However, when the neural network is evaluated using a different test dataset (D_{T}), results may be unsatisfactory (e.g., visible artifacts in generated images). Unsatisfactory results may occur for one or more reasons. A first exemplary reason occurs when the loss function L_{S} is different than a test loss function (L_{T}); consequently, training to optimize against the loss function L_{S} may be inadequate when assessment is made with respect to the test loss function L_{T}. In this case, the loss function (L_{S}), may provide inadequate loss feedback to train the neural network G_{S} in a way that avoids visual artifacts, which may only be significant to L_{T}. This case is especially challenging when the test loss function involves a subjective human viewer.

A second exemplary reason for unsatisfactory results may occur when a distribution for the first training dataset (D_{S}) is sufficiently different than the distribution for the test dataset (D_{T}). In this case, the first training dataset may lack sufficient representative data to train the neural network G_{S} in a way that avoids visual artifacts. A third exemplary reason for unsatisfactory results may occur when the first set of hyperparameters (H_{S}) is sub-optimally tuned. However, optimizing hyperparameters (H_{S}) alone to overcome training shortfalls may be impractical in general.

When any one of the above three reasons for unsatisfactory results is operable in a neural network training usage case, simply retraining the neural network G_{S} conventionally may not necessarily improve the quality of an evaluation outcome. Improving L_{S} to match L_{T} may be impractical; capturing a sufficiently large training dataset may be impractical; and, optimizing H_{S} may be impractical. However, the microtraining technique disclosed herein provides a mechanism for improving results without overcoming impractical hurdles.

In an embodiment, S is equal to zero and the neural network G_{S} is a trained neural network (G₀), which was trained using a first training dataset (D₀) and a first set of hyperparameters (H₀). In various usage cases, the trained neural network may generate output data that includes visual artifacts. The artifacts may include, without limitation, geometric aliasing artifacts (e.g., jagged edges, blocky appearance), noise artifacts (e.g., rendering noise artifacts), lighting effect artifacts (e.g., water reflection artifacts), and temporal artifacts (e.g., shimmering, swimming appearances).

At step 113, the processing unit receives a second training dataset (D₁). The second training dataset Di may include additional training samples selected to specifically train the neural network to suppress the visual artifacts. For example, to improve anti-aliasing quality, additional images depicting thin, high-contrast lines may be procured and mixed in with the second training dataset (D₁) for use during microtraining to guide the neural network G₁ to produce more continuous and aesthetically pleasing anti-aliased lines without disturbing other valuable training. At step 115, the processing unit receives a second set of hyperparameters (H₁). In an embodiment, a second learning parameter is specified in the second set of hyperparameters to limit adjustments of one or more weights used by the neural network compared with a corresponding first learning parameter in the first set of hyperparameters. In an embodiment, the first learning parameter comprises a first learning rate, and the second learning parameter comprises a second learning rate that is less than the first learning rate. In certain embodiments, the second learning rate ranges from ten times lower through over one thousand times lower than the first learning rate. For example, the first learning rate may be in the range of 1e-3 to 1e-5, while the second learning rate may be in the range of 1e-4 to 1e-8.

In an embodiment, the first set of hyperparameters comprises a first training iteration count and the second set of hyperparameters comprises a second training iteration count that is less than the first training iteration count. In certain embodiments, the second training iteration count is one thousand times (or more) smaller than the first training iteration count. More generally, the second set of hyperparameters may specify a total computational effort for training that may be hundreds to thousands (or more) of times smaller than the total computational effort specified by the first set of hyperparameters.

At step 117, the processing unit applies the second training dataset to the neural network according to the second set of hyperparameters while adjusting the one or more weights used by the neural network to process the second training dataset to produce a first microtrained neural network. In this way, the first microtrained neural network (G₁) represents an additionally trained instance of the trained neural network (G₀).

In an embodiment, the processing unit applies the second training dataset in combination with at least a portion of the first training dataset to produce the first microtrained neural network. For example, the entire second training dataset along with the entire first training dataset may be used to train and produce the first microtrained neural network. In another example, the entire second training dataset along with approximately half of the first training dataset may be used. Alternatively, various other combinations of the second training dataset and the first training dataset may be applied to train and produce the first microtrained neural network. In an embodiment, the second training iteration count is used to train and produce the first microtrained neural network.

In an embodiment, each weight of the first microtrained neural network may be adjusted during microtraining. In alternative embodiments, certain weights, such as weights associated with a particular layer, may be locked down and not adjusted during the microtraining.

In an embodiment, the trained neural network implements a U-Net architecture with a first set of activation function weights and the first microtrained neural network implements a corresponding U-Net architecture with a second, different set of activation function weights. In various embodiments, the trained neural network and the first microtrained neural network comprise networks within a generative adversarial neural network (GAN) system. A GAN typically includes a generator network and a discriminator network, each of which may be a deep neural network such as a U-Net with an arbitrarily deep architecture. The GAN structure pits the generator network against the discriminator network, with the generator network learning to generate synthetic data that is indistinguishable from natural data, and the discriminator network learning to distinguish synthetic data from natural data. In certain applications, the generator network may be trained to generate high-quality synthetic data, such as synthetic, imaginary images. In other applications, the discriminator network learns to generalize recognition beyond natural or initial training data. In the context of the present disclosure, any technically feasible training mechanism (e.g., back propagation) may be performed during training without departing the scope and spirit of various embodiments.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

FIG. 1B illustrates microtraining within an overall hypothesis space 140, in accordance with an embodiment. As shown, an untrained neural network G_{U} traverses an initial training path 142, resulting in a trained neural network G₀. The initial training path 142 may be traversed according to any technically feasible training technique. The trained neural network G₀ is positioned within a local optimization region 144, but the trained neural network G₀ may not actually provide an ideal outcome 146 based on the first training dataset D₀ and a first set of hyperparameters H₀. The disclosed methods 110 and 200 refine the trained neural network G₀ to get closer to the ideal outcome 146. In this example, trained neural network G₀ is refined through a path going from trained neural network G₀ to microtrained neural networks G₁, G₂, and finally G₃. Furthermore, the technique provides for subjective human input to better align automated training results with human perception to increase quality in ways that may be visually important and distinct to human perception, but difficult to algorithmically model in the form of automated loss functions.

As shown, an initial training outcome results in the trained neural network G₀ using training dataset D₀, a loss function, and hyperparameters H₀. An improved training outcome using the disclosed microtraining technique results in refined neural network G₃, which is closer to the ideal outcome 146. Small changes to the trained neural network G₀ during microtraining preserve the benefit of the original training with training dataset D₀, while allowing small modifications that may improve quality. For example, refined neural network G₁ may generally replicate trained neural network G₀, but with the addition of small changes to activation function weights that provide improved quality.

The disclosed microtraining technique includes receiving a trained neural network G₀ (G_{S}, s=0), receiving a second training dataset (e.g., D₁), receiving a second set of hyperparameters H₁, and training a new microtrained neural network G_{S+1}, based on neural network G_{S}. During a first microtraining session, neural network G₁ is produced from neural network G₀. In an embodiment, additional training samples may be added into subsequent second training datasets (e.g., D₂, D₃, and so forth) and each subsequent microtraining session (e.g., iteration) may produce a subsequent neural network G₂, G₃, and so forth. Multiple microtraining sessions may be performed to further refine a subsequent neural network G_{S+n}. Microtraining generally maintains the internal computational structure of a trained neural network, allowing comparison and interpolation operations to be performed on outputs of an original trained neural network (G_{S}) and subsequently microtrained neural networks G_{S+1}. As shown, the disclosed techniques allow microtrained neural network G₃ to provide outcomes that may be closer to the ideal outcome 146 than a conventionally trained neural network G₀. Furthermore, the disclosed techniques provide neural network quality improvement while advantageously requiring only modest additional computational effort beyond initial training because orders of magnitude fewer training iterations are needed for microtraining compared to conventional training.

In one exemplary usage case, after the microtrained neural network is produced, certain training data may be processed by the microtrained neural network, with results displayed to the viewer for assessment. If the results are assessed to be acceptable, then the viewer may provide input into a user interface indicating the completion requirements have been satisfied. In this example, the viewer may be assessing visual artifacts associated with anti-aliasing, noise reduction, lighting effects, and so forth. Such visual artifacts may be difficult to quantify algorithmically as being better or worse with respect to a previous training session, but the viewer may easily provide a subjective assessment based on human perception of the artifacts. Furthering the example, the second training dataset may be constructed to include training data that specifically addresses the visual artifacts being targeted by the microtraining. In the specific application of anti-aliasing, a small fraction of one percent of overall screen pixels may have artifacts, such as artifacts associated with thin, high-contrast lines (e.g., dark telephone wires against a light sky in an outdoors scene). With just a few pixels impacted by certain aliasing artifacts, conventional training techniques may not reliably produce high quality results for those few pixels; however, these aliasing artifacts can be very apparent to a human viewer and can noticeably diminish image quality.

FIG. 1C illustrates a neural network framework 170, in accordance with an embodiment. As shown, the neural network framework 170 includes a discriminator 178 configured to receive a reference sample 176 comprising reference image data or a synthetic sample 186 comprising synthetic image data. The discriminator 178 generates a loss output used by a parameter adjustment unit 180 for calculating adjustments to respective neural network parameters. In the context of the following description, the loss represents a confidence level that the selected sample 176 or 186 is a reference sample and not a synthetic sample. The parameter adjustment unit 180 also receives hyperparameters as inputs. The reference sample 176 may be selected from a training dataset 174, comprising captured images from real world scenes to be used as reference sample images 175. The sample 186 is synthesized by generator 184 based on prior training and a latent random variable 182, and/or other inputs. In an embodiment the generator 184 comprises a first neural network and the discriminator 178 comprises a second neural network.

In an embodiment, the neural network framework 170 is configured to operate in a generative adversarial network (GAN) mode, wherein the discriminator 178 is trained to identify “real” reference sample images 175, while the generator 184 is trained to synthesize “fake” samples 186. In an embodiment, the discriminator 178 trains on samples 176, with each training pass including a forward pass in which a sample 176 is evaluated and a reverse pass in which weights and/or biases within the discriminator 178 are adjusted using, for example, back propagation techniques. Furthermore, the generator 184 then trains to synthesize a sample 186 that can trick the discriminator 178. Each training pass includes a forward pass in which the sample 186 is synthesized, and a reverse pass in which weights and/or biases within the generator 184 are adjusted (e.g., using back propagation). In an embodiment, parameter adjustment unit 180 performs back propagation to calculate new neural network parameters (e.g., weights and/or biases) resulting from a given training pass.

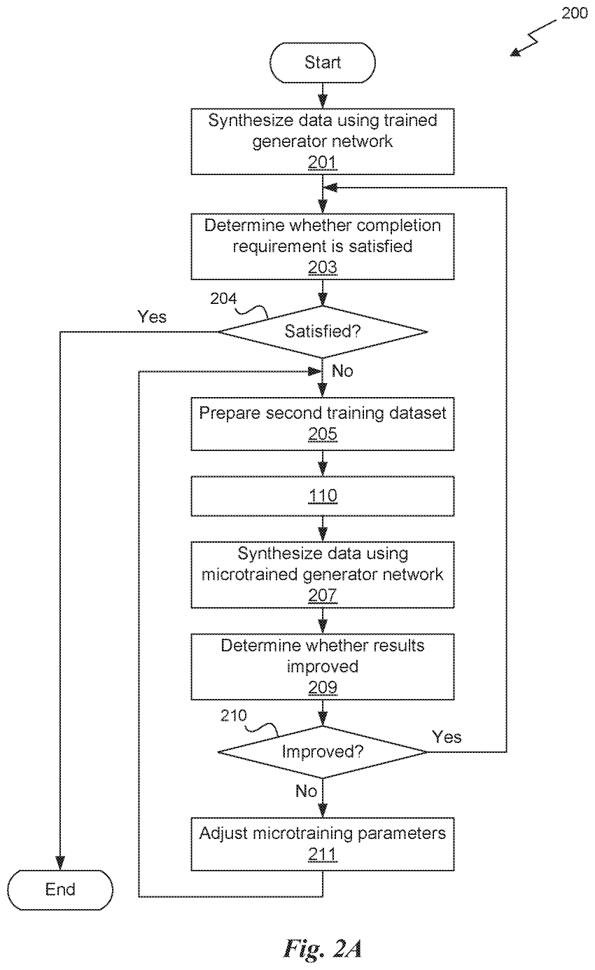

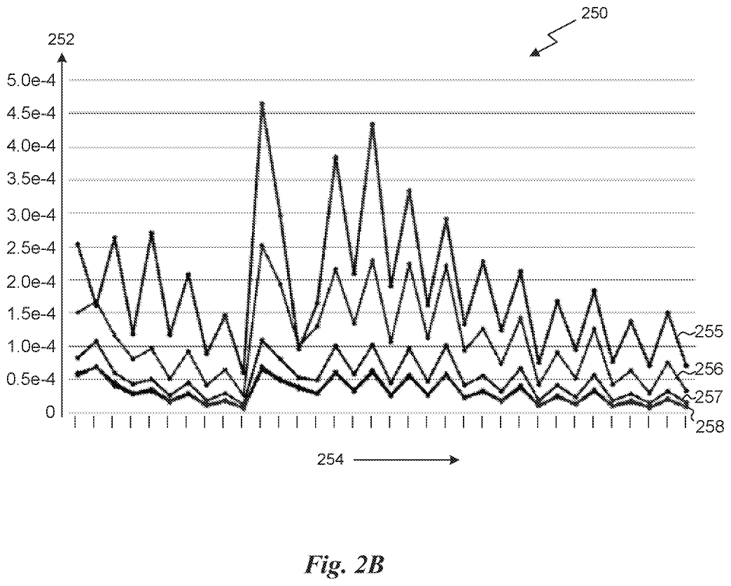

In the process of adversarial training, the discriminator 178 may learn to better generalize, while the generator 184 may learn to better synthesize. Both improvements may be separately useful. In certain usage cases, such as image enhancement (e.g., super-resolution/up-sampling, anti-aliasing, denoising, etc.), training refinement may be required to overcome artifacts in images synthesized by initially trained neural network G₀ within the generator 184. Such training refinement may be provided when the neural network framework 170 is configured to perform the microtraining method 110 described in FIG. 1A, and/or method 200 described in FIG. 2A.

In an embodiment, the neural network framework 170 is configured to operate in a microtraining mode, with sample images 175 selected to specifically target deficiencies in the initially trained neural network G₀. In the microtraining mode, the generator 184 generates sample 186, which is displayed by user interface 188 on a display device. The sample 186 may be displayed next to a previously generated sample and the viewer may determine whether the sample 186 is an improvement over the previously generated sample. Furthermore, the user interface 188 may display a set of samples 186 on the display device and receive input from the viewer indicating whether the generator 184 has been sufficiently trained during microtraining. In an embodiment, the neural network framework 170 is configured to perform method 110 described in FIG. 1A and method 200 described in FIG. 2A. The neural network framework 170 may also perform conventional training techniques, including techniques for GAN training. In an embodiment, conventional and/or GAN training may use the first set of hyperparameters, while microtraining may use the second set of hyperparameters.

FIG. 2A illustrates a flowchart of a method 200 for improving neural network training using microtraining, in accordance with an embodiment. Although method 200 is described in the context of a processing unit, the method 200 may also be performed by a program, custom circuitry, or by a combination of custom circuitry and a program. For example, the method 200 may be executed by a GPU (graphics processing unit), CPU (central processing unit), or any processor capable of performing operations for evaluating and training neural networks. Furthermore, persons of ordinary skill in the art will understand that any system that performs method 200 is within the scope and spirit of embodiments of the present disclosure. In an embodiment, a processing unit performs method 200 in conjunction with various operations of a neural network training framework and/or a neural network runtime system. In certain embodiments, the processing unit includes one or more instances of a parallel processing unit, such as parallel processing unit 300 of FIG. 3. In an embodiment, the neural network framework 170 described in FIG. 1C is implemented, at least in part, on the processing unit and configured to perform method 200.

Method 200 begins at step 201, where the processing unit synthesizes a first set of data using a generator neural network. In an embodiment, the generator neural network comprises the trained neural network of the method 110. In an embodiment, the synthesized data includes one or more images (e.g., video frames). The images may be generated according to any technically feasible techniques, including techniques known in the art for deep learning super-sampling (DLSS), super-resolution/up-sampling, and/or anti-aliasing, denoising, and so forth provided by a neural network configured to act as a generator network.

At step 203, a determination is made whether a completion requirement is satisfied. Any technically feasible technique may be performed to determine that the completion requirement is satisfied. In an embodiment, the synthesized one or more images are presented on a display device to a human viewer, and the completion requirement is satisfied if the quality of the one or more images is assessed by the viewer to be sufficiently good. For example, a user interface, such as the user interface 188, may receive an input from the viewer indicating that the results are acceptable and therefore the completion requirement is satisfied. In an embodiment, the user interface executes on the processing unit, with images and user interface tools presented on the display device.

If, at step 204, the completion requirement is satisfied, then the method 200 terminates. Otherwise, if the completion requirement is not satisfied, then the method 200 proceeds to 205. To complete step 204, the processing unit receives an indication that the completion requirement is satisfied. In an embodiment, the completion requirement is satisfied when the user interface receives an input indication that microtraining has produced sufficiently good results.

At step 205, the processing unit prepares the second training dataset. In an embodiment, preparing the second training dataset may include receiving input by the user interface to select images to be included within the second training dataset. The images may be selected to better align the distribution of target output data included in the training dataset D_{S} that is used during microtraining of a generator neural network with test requirements for the generator neural network represented by the test dataset D_{T}. Preparing the second training dataset may include, without limitation, capturing additional training samples that specifically target visual artifacts and/or image features identified by the viewer to be removed by microtraining. Preparing the second training dataset may further include, without limitation, removing samples that may have errors or omissions from the first training dataset, recapturing erroneous samples, and adding/modifying/augmenting the first training dataset to more closely align training distributions of the second training dataset with the test dataset. The method 200 then proceeds to execute method 110 of FIG. 1A to produce a microtrained generator network. Upon completing method 110 the method 200 proceeds to step 207.

At step 207, the processing unit synthesizes a second set of data using the microtrained generator network. In an embodiment, the synthesized data includes one or more images (e.g., video frames). The images may be generated according to any technically feasible techniques, including techniques known in the art for deep learning super-sampling (DLSS), super-resolution/up-sampling, and/or anti-aliasing, denoising, and so forth provided by a neural network configured to act as a generator network.

At step 209, a determination is made whether results improved between the first set of data and the second set of data. In an embodiment, images comprising the first set of data are compared to corresponding images comprising the second set of data on a display device to a human viewer. The quality of the displayed images may be assessed by the viewer. A determination that results improved may be made, for example, by a user interface receiving an input from the viewer indicating that the results improved. In an embodiment, the user interface executes on the processing unit, with images and user interface tools presented on the display device.

If, at step 210, the results improved, then the method proceeds back to step 203. Otherwise, the method proceeds to step 211. At step 211, the processing unit adjusts one or more microtraining parameters. Furthermore, the processing unit may discard the microtrained neural network generated previously by method 110. Adjusting the one or more microtraining parameters may include, without limitation, adding training samples (e.g., images) to the second training dataset, removing training samples from the second training dataset, and adjusting one or more hyperparameters such as learning rate, iteration count, and so forth. In an embodiment, adjusting the one or more microtraining parameters is performed by a viewer through a user interface. Upon completing step 211, the method returns back to step 205.

Multiple passes through method steps 203 through 211 may be performed until the completion requirement is satisfied at step 204 and the user interface receives an input indication that microtraining has produced sufficiently good results. During each microtraining session of method 110, a subsequent new neural network (e.g., G₁, G₂, G₃, and so forth) is produced. Each new neural network may be kept or discarded depending on whether the new neural network improves results.

In an embodiment, method 110 and/or method 200 may perform transfer learning to produce a new neural network G_{S+n} that is optimized for a different application than the initially trained neural network G₀. In another embodiment, method 110 and/or method 200 may be performed to improve generalization, such as in a discriminator network.

More generally, the disclosed techniques provide rapid refinement training for existing (e.g., pre-trained) neural networks, quick refinement to new application using only a small training set targeting the new application, and a mechanism to loop in a human operator in the training loop.

FIG. 2B illustrates a plot 250 of average differences between layers of various microtrained networks, in accordance with an embodiment. As shown, the vertical axis 252 indicates overall differences between layer coefficients (weights and biases) of various microtrained neural networks (G₁, G₂, etc.) produced from the same parent (i.e., initially trained neural network G₀), but with different microtraining or degrees of microtraining, indicated by lines 255, 256, 257, and 258. The horizontal axis 254 includes discrete markers, each indicating alternating weights and biases for different neural network layers for a particular neural network topology. As shown, differences in layer coefficients indicated by line 255 are generally greater than differences in layer coefficients indicated by line 258. Furthermore, a neural network associated with line 255 has been microtrained to be further away from the parent neural network than a neural network associated with line 258.

As illustrated in the overall shape of weight and bias differences for the various microtrained neural networks, small iteration steps and low learning rates associated with microtraining do not change the overall computational structure of microtrained neural networks. Preserving the computational structure between neural networks provides for operations such as comparison and interpolation among a parent network and different networks produced using microtraining. For example, an image sharpening neural network may be trained to improve the sharpness of a synthesized output image, however resulting output images may be assessed to be over-sharpened; thus, an average or interpolation of weights between the parent neural network and the image sharpening neural network may be used to reduce the degree of sharpness. Such an interpolation step only requires interpolation of weights and biases, but does not require any additional training. More generally, computational composition may be performed between and among a parent neural networks and microtrained networks produced from the parent neural networks.

### Parallel Processing Architecture

FIG. 3 illustrates a parallel processing unit (PPU) 300, in accordance with an embodiment. In an embodiment, the PPU 300 is a multi-threaded processor that is implemented on one or more integrated circuit devices. The PPU 300 is a latency hiding architecture designed to process many threads in parallel. A thread (e.g., a thread of execution) is an instantiation of a set of instructions configured to be executed by the PPU 300. In an embodiment, the PPU 300 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 300 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 300 may be configured to accelerate thousands of High Performance Computing (HPC), data center, and machine learning applications. The PPU 300 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 3, the PPU 300 includes an Input/Output (I/O) unit 305, a front end unit 315, a scheduler unit 320, a work distribution unit 325, a hub 330, a crossbar (Xbar) 370, one or more general processing clusters (GPCs) 350, and one or more memory partition units 380. The PPU 300 may be connected to a host processor or other PPUs 300 via one or more high-speed NVLink 310 interconnect. The PPU 300 may be connected to a host processor or other peripheral devices via an interconnect 302. The PPU 300 may also be connected to a local memory 304 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

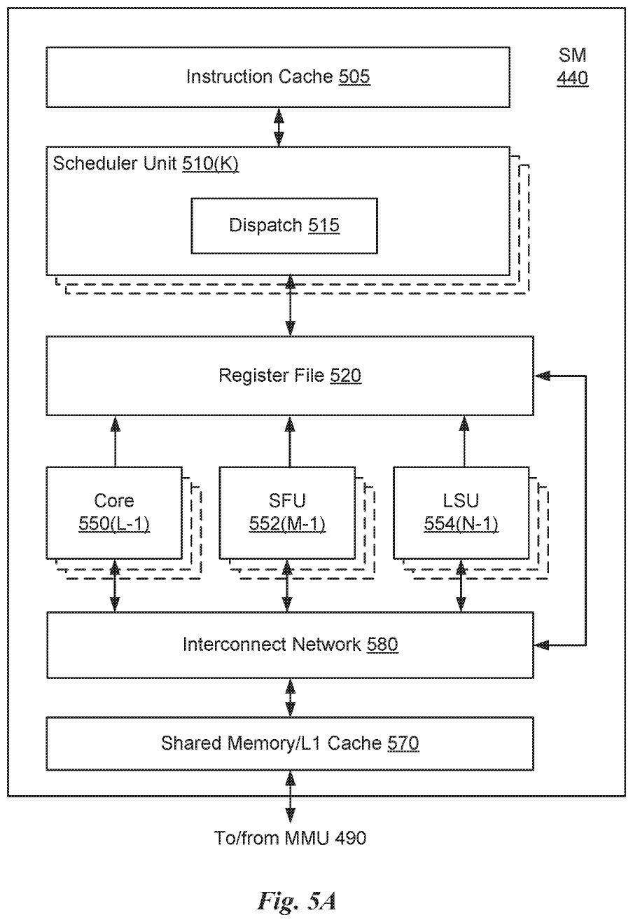

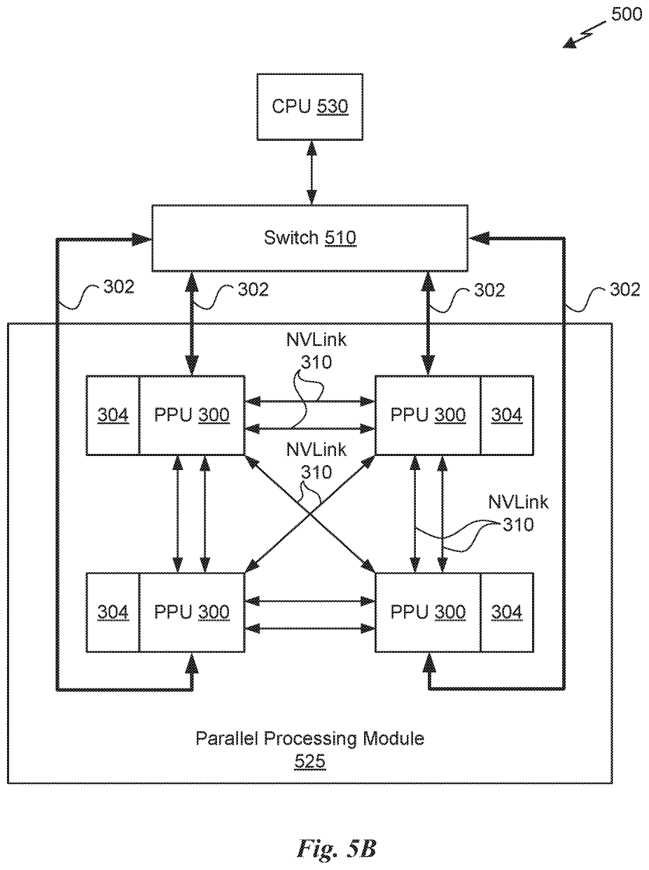

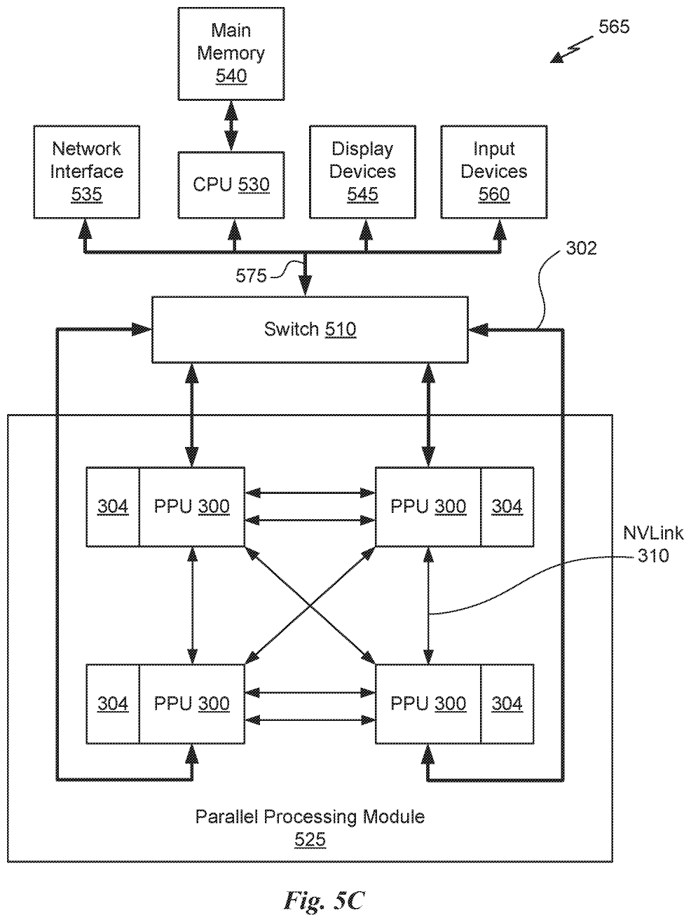

The NVLink 310 interconnect enables systems to scale and include one or more PPUs 300 combined with one or more CPUs, supports cache coherence between the PPUs 300 and CPUs, and CPU mastering. Data and/or commands may be transmitted by the NVLink 310 through the hub 330 to/from other units of the PPU 300 such as one or more copy engines, a video encoder, a video decoder, a power management unit, etc. (not explicitly shown). The NVLink 310 is described in more detail in conjunction with FIG. 5B.

The I/O unit 305 is configured to transmit and receive communications (e.g., commands, data, etc.) from a host processor (not shown) over the interconnect 302. The I/O unit 305 may communicate with the host processor directly via the interconnect 302 or through one or more intermediate devices such as a memory bridge. In an embodiment, the I/O unit 305 may communicate with one or more other processors, such as one or more the PPUs 300 via the interconnect 302. In an embodiment, the I/O unit 305 implements a Peripheral Component Interconnect Express (PCIe) interface for communications over a PCIe bus and the interconnect 302 is a PCIe bus. In alternative embodiments, the I/O unit 305 may implement other types of well-known interfaces for communicating with external devices.

The I/O unit 305 decodes packets received via the interconnect 302. In an embodiment, the packets represent commands configured to cause the PPU 300 to perform various operations. The I/O unit 305 transmits the decoded commands to various other units of the PPU 300 as the commands may specify. For example, some commands may be transmitted to the front end unit 315. Other commands may be transmitted to the hub 330 or other units of the PPU 300 such as one or more copy engines, a video encoder, a video decoder, a power management unit, etc. (not explicitly shown). In other words, the I/O unit 305 is configured to route communications between and among the various logical units of the PPU 300.

In an embodiment, a program executed by the host processor encodes a command stream in a buffer that provides workloads to the PPU 300 for processing. A workload may comprise several instructions and data to be processed by those instructions. The buffer is a region in a memory that is accessible (e.g., read/write) by both the host processor and the PPU 300. For example, the I/O unit 305 may be configured to access the buffer in a system memory connected to the interconnect 302 via memory requests transmitted over the interconnect 302. In an embodiment, the host processor writes the command stream to the buffer and then transmits a pointer to the start of the command stream to the PPU 300. The front end unit 315 receives pointers to one or more command streams. The front end unit 315 manages the one or more streams, reading commands from the streams and forwarding commands to the various units of the PPU 300.

The front end unit 315 is coupled to a scheduler unit 320 that configures the various GPCs 350 to process tasks defined by the one or more streams. The scheduler unit 320 is configured to track state information related to the various tasks managed by the scheduler unit 320. The state may indicate which GPC 350 a task is assigned to, whether the task is active or inactive, a priority level associated with the task, and so forth. The scheduler unit 320 manages the execution of a plurality of tasks on the one or more GPCs 350.

The scheduler unit 320 is coupled to a work distribution unit 325 that is configured to dispatch tasks for execution on the GPCs 350. The work distribution unit 325 may track a number of scheduled tasks received from the scheduler unit 320. In an embodiment, the work distribution unit 325 manages a pending task pool and an active task pool for each of the GPCs 350. The pending task pool may comprise a number of slots (e.g., 32 slots) that contain tasks assigned to be processed by a particular GPC 350. The active task pool may comprise a number of slots (e.g., 4 slots) for tasks that are actively being processed by the GPCs 350. As a GPC 350 finishes the execution of a task, that task is evicted from the active task pool for the GPC 350 and one of the other tasks from the pending task pool is selected and scheduled for execution on the GPC 350. If an active task has been idle on the GPC 350, such as while waiting for a data dependency to be resolved, then the active task may be evicted from the GPC 350 and returned to the pending task pool while another task in the pending task pool is selected and scheduled for execution on the GPC 350.

The work distribution unit 325 communicates with the one or more GPCs 350 via XBar 370. The XBar 370 is an interconnect network that couples many of the units of the PPU 300 to other units of the PPU 300. For example, the XBar 370 may be configured to couple the work distribution unit 325 to a particular GPC 350. Although not shown explicitly, one or more other units of the PPU 300 may also be connected to the XBar 370 via the hub 330.

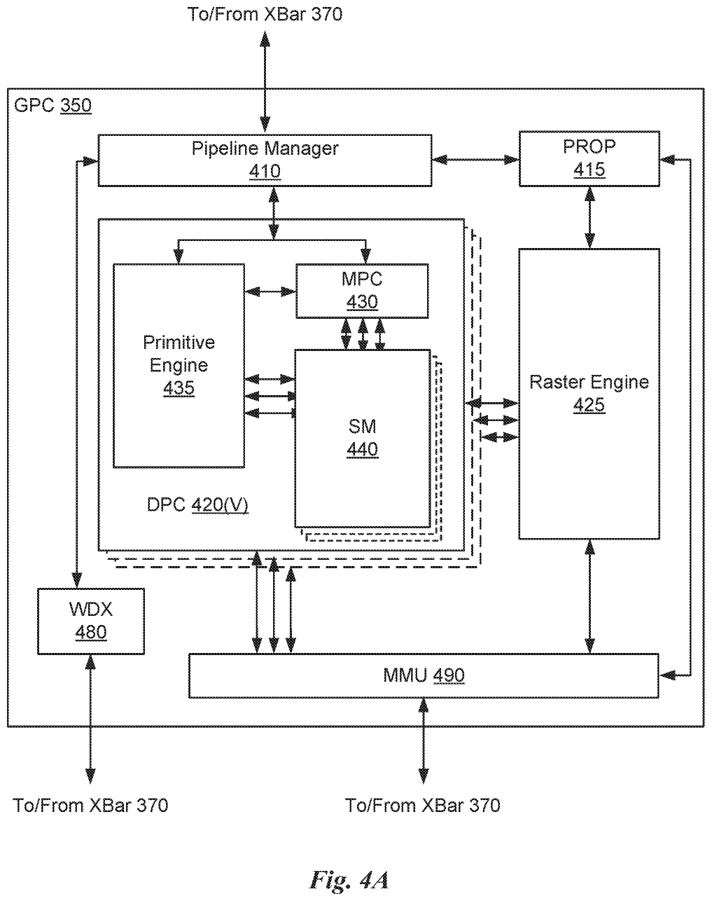

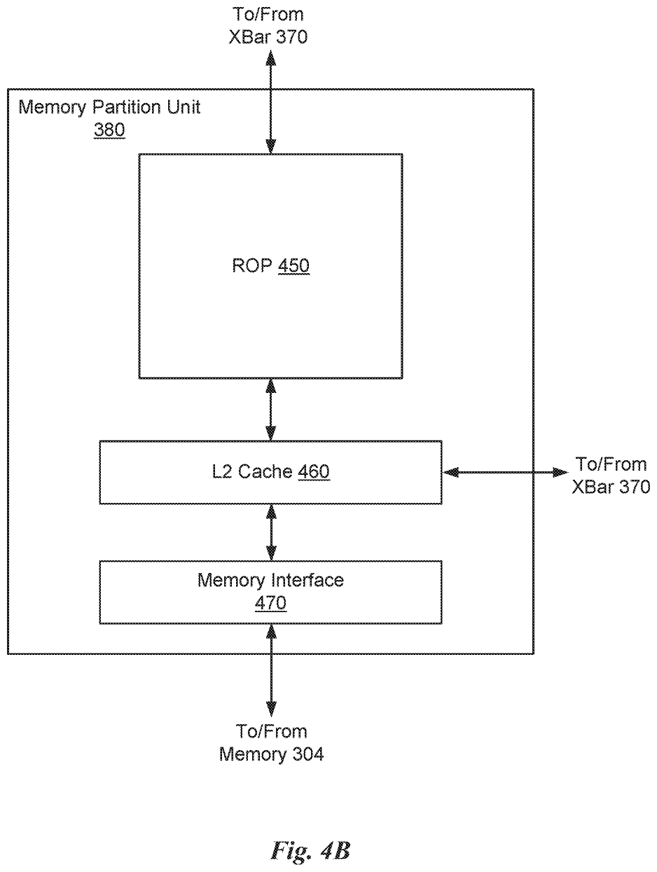

The tasks are managed by the scheduler unit 320 and dispatched to a GPC 350 by the work distribution unit 325. The GPC 350 is configured to process the task and generate results. The results may be consumed by other tasks within the GPC 350, routed to a different GPC 350 via the XBar 370, or stored in the memory 304. The results can be written to the memory 304 via the memory partition units 380, which implement a memory interface for reading and writing data to/from the memory 304. The results can be transmitted to another PPU 300 or CPU via the NVLink 310. In an embodiment, the PPU 300 includes a number U of memory partition units 380 that is equal to the number of separate and distinct memory devices of the memory 304 coupled to the PPU 300. A memory partition unit 380 will be described in more detail below in conjunction with FIG. 4B.

In an embodiment, a host processor executes a driver kernel that implements an application programming interface (API) that enables one or more applications executing on the host processor to schedule operations for execution on the PPU 300. In an embodiment, multiple compute applications are simultaneously executed by the PPU 300 and the PPU 300 provides isolation, quality of service (QoS), and independent address spaces for the multiple compute applications. An application may generate instructions (e.g., API calls) that cause the driver kernel to generate one or more tasks for execution by the PPU 300. The driver kernel outputs tasks to one or more streams being processed by the PPU 300. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 5A.

FIG. 4A illustrates a GPC 350 of the PPU 300 of FIG. 3, in accordance with an embodiment. As shown in FIG. 4A, each GPC 350 includes a number of hardware units for processing tasks. In an embodiment, each GPC 350 includes a pipeline manager 410, a pre-raster operations unit (PROP) 415, a raster engine 425, a work distribution crossbar (WDX) 480, a memory management unit (MMU) 490, and one or more Data Processing Clusters (DPCs) 420. It will be appreciated that the GPC 350 of FIG. 4A may include other hardware units in lieu of or in addition to the units shown in FIG. 4A.

In an embodiment, the operation of the GPC 350 is controlled by the pipeline manager 410. The pipeline manager 410 manages the configuration of the one or more DPCs 420 for processing tasks allocated to the GPC 350. In an embodiment, the pipeline manager 410 may configure at least one of the one or more DPCs 420 to implement at least a portion of a graphics rendering pipeline. For example, a DPC 420 may be configured to execute a vertex shader program on the programmable streaming multiprocessor (SM) 440. The pipeline manager 410 may also be configured to route packets received from the work distribution unit 325 to the appropriate logical units within the GPC 350. For example, some packets may be routed to fixed function hardware units in the PROP 415 and/or raster engine 425 while other packets may be routed to the DPCs 420 for processing by the primitive engine 435 or the SM 440. In an embodiment, the pipeline manager 410 may configure at least one of the one or more DPCs 420 to implement a neural network model and/or a computing pipeline.

The PROP unit 415 is configured to route data generated by the raster engine 425 and the DPCs 420 to a Raster Operations (ROP) unit, described in more detail in conjunction with FIG. 4B. The PROP unit 415 may also be configured to perform optimizations for color blending, organize pixel data, perform address translations, and the like.

The raster engine 425 includes a number of fixed function hardware units configured to perform various raster operations. In an embodiment, the raster engine 425 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 425 comprises fragments to be processed, for example, by a fragment shader implemented within a DPC 420.

Each DPC 420 included in the GPC 350 includes an M-Pipe Controller (MPC) 430, a primitive engine 435, and one or more SMs 440. The MPC 430 controls the operation of the DPC 420, routing packets received from the pipeline manager 410 to the appropriate units in the DPC 420. For example, packets associated with a vertex may be routed to the primitive engine 435, which is configured to fetch vertex attributes associated with the vertex from the memory 304. In contrast, packets associated with a shader program may be transmitted to the SM 440.

The SM 440 comprises a programmable streaming processor that is configured to process tasks represented by a number of threads. Each SM 440 is multi-threaded and configured to execute a plurality of threads (e.g., 32 threads) from a particular group of threads concurrently. In an embodiment, the SM 440 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 440 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 440 will be described in more detail below in conjunction with FIG. 5A.

The MMU 490 provides an interface between the GPC 350 and the memory partition unit 380. The MMU 490 may provide translation of virtual addresses into physical addresses, memory protection, and arbitration of memory requests. In an embodiment, the MMU 490 provides one or more translation lookaside buffers (TLBs) for performing translation of virtual addresses into physical addresses in the memory 304.

FIG. 4B illustrates a memory partition unit 380 of the PPU 300 of FIG. 3, in accordance with an embodiment. As shown in FIG. 4B, the memory partition unit 380 includes a Raster Operations (ROP) unit 450, a level two (L2) cache 460, and a memory interface 470. The memory interface 470 is coupled to the memory 304. Memory interface 470 may implement 32, 64, 128, 1024-bit data buses, or the like, for high-speed data transfer. In an embodiment, the PPU 300 incorporates U memory interfaces 470, one memory interface 470 per pair of memory partition units 380, where each pair of memory partition units 380 is connected to a corresponding memory device of the memory 304. For example, PPU 300 may be connected to up to Y memory devices, such as high bandwidth memory stacks or graphics double-data-rate, version 5, synchronous dynamic random access memory, or other types of persistent storage.

In an embodiment, the memory interface 470 implements an HBM2 memory interface and Y equals half U. In an embodiment, the HBM2 memory stacks are located on the same physical package as the PPU 300, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 304 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 300 process very large datasets and/or run applications for extended periods.

In an embodiment, the PPU 300 implements a multi-level memory hierarchy. In an embodiment, the memory partition unit 380 supports a unified memory to provide a single unified virtual address space for CPU and PPU 300 memory, enabling data sharing between virtual memory systems. In an embodiment the frequency of accesses by a PPU 300 to memory located on other processors is traced to ensure that memory pages are moved to the physical memory of the PPU 300 that is accessing the pages more frequently. In an embodiment, the NVLink 310 supports address translation services allowing the PPU 300 to directly access a CPU's page tables and providing full access to CPU memory by the PPU 300.

In an embodiment, copy engines transfer data between multiple PPUs 300 or between PPUs 300 and CPUs. The copy engines can generate page faults for addresses that are not mapped into the page tables. The memory partition unit 380 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 304 or other system memory may be fetched by the memory partition unit 380 and stored in the L2 cache 460, which is located on-chip and is shared between the various GPCs 350. As shown, each memory partition unit 380 includes a portion of the L2 cache 460 associated with a corresponding memory 304. Lower level caches may then be implemented in various units within the GPCs 350. For example, each of the SMs 440 may implement a level one (L1) cache. The L1 cache is private memory that is dedicated to a particular SM 440. Data from the L2 cache 460 may be fetched and stored in each of the L1 caches for processing in the functional units of the SMs 440. The L2 cache 460 is coupled to the memory interface 470 and the XBar 370.

The ROP unit 450 performs graphics raster operations related to pixel color, such as color compression, pixel blending, and the like. The ROP unit 450 also implements depth testing in conjunction with the raster engine 425, receiving a depth for a sample location associated with a pixel fragment from the culling engine of the raster engine 425. The depth is tested against a corresponding depth in a depth buffer for a sample location associated with the fragment. If the fragment passes the depth test for the sample location, then the ROP unit 450 updates the depth buffer and transmits a result of the depth test to the raster engine 425. It will be appreciated that the number of memory partition units 380 may be different than the number of GPCs 350 and, therefore, each ROP unit 450 may be coupled to each of the GPCs 350. The ROP unit 450 tracks packets received from the different GPCs 350 and determines which GPC 350 that a result generated by the ROP unit 450 is routed to through the Xbar 370. Although the ROP unit 450 is included within the memory partition unit 380 in FIG. 4B, in other embodiment, the ROP unit 450 may be outside of the memory partition unit 380. For example, the ROP unit 450 may reside in the GPC 350 or another unit.

FIG. 5A illustrates the streaming multi-processor 440 of FIG. 4A, in accordance with an embodiment. As shown in FIG. 5A, the SM 440 includes an instruction cache 505, one or more scheduler units 510, a register file 520, one or more processing cores 550, one or more special function units (SFUs) 552, one or more load/store units (LSUs) 554, an interconnect network 580, a shared memory/L1 cache 570.

As described above, the work distribution unit 325 dispatches tasks for execution on the GPCs 350 of the PPU 300. The tasks are allocated to a particular DPC 420 within a GPC 350 and, if the task is associated with a shader program, the task may be allocated to an SM 440. The scheduler unit 510 receives the tasks from the work distribution unit 325 and manages instruction scheduling for one or more thread blocks assigned to the SM 440. The scheduler unit 510 schedules thread blocks for execution as warps of parallel threads, where each thread block is allocated at least one warp. In an embodiment, each warp executes 32 threads. The scheduler unit 510 may manage a plurality of different thread blocks, allocating the warps to the different thread blocks and then dispatching instructions from the plurality of different cooperative groups to the various functional units (e.g., cores 550, SFUs 552, and LSUs 554) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( )) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 515 is configured to transmit instructions to one or more of the functional units. In the embodiment, the scheduler unit 510 includes two dispatch units 515 that enable two different instructions from the same warp to be dispatched during each clock cycle. In alternative embodiments, each scheduler unit 510 may include a single dispatch unit 515 or additional dispatch units 515.

Each SM 440 includes a register file 520 that provides a set of registers for the functional units of the SM 440. In an embodiment, the register file 520 is divided between each of the functional units such that each functional unit is allocated a dedicated portion of the register file 520. In another embodiment, the register file 520 is divided between the different warps being executed by the SM 440. The register file 520 provides temporary storage for operands connected to the data paths of the functional units.

Each SM 440 comprises L processing cores 550. In an embodiment, the SM 440 includes a large number (e.g., 128, etc.) of distinct processing cores 550. Each core 550 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 550 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 550. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 440 also comprises M SFUs 552 that perform special functions (e.g., attribute evaluation, reciprocal square root, and the like). In an embodiment, the SFUs 552 may include a tree traversal unit configured to traverse a hierarchical tree data structure. In an embodiment, the SFUs 552 may include texture unit configured to perform texture map filtering operations. In an embodiment, the texture units are configured to load texture maps (e.g., a 2D array of texels) from the memory 304 and sample the texture maps to produce sampled texture values for use in shader programs executed by the SM 440. In an embodiment, the texture maps are stored in the shared memory/L1 cache 470. The texture units implement texture operations such as filtering operations using mip-maps (e.g., texture maps of varying levels of detail). In an embodiment, each SM 340 includes two texture units.

Each SM 440 also comprises NLSUs 554 that implement load and store operations between the shared memory/L1 cache 570 and the register file 520. Each SM 440 includes an interconnect network 580 that connects each of the functional units to the register file 520 and the LSU 554 to the register file 520, shared memory/L1 cache 570. In an embodiment, the interconnect network 580 is a crossbar that can be configured to connect any of the functional units to any of the registers in the register file 520 and connect the LSUs 554 to the register file and memory locations in shared memory/L1 cache 570.

The shared memory/L1 cache 570 is an array of on-chip memory that allows for data storage and communication between the SM 440 and the primitive engine 435 and between threads in the SM 440. In an embodiment, the shared memory/L1 cache 570 comprises 128 KB of storage capacity and is in the path from the SM 440 to the memory partition unit 380. The shared memory/L1 cache 570 can be used to cache reads and writes. One or more of the shared memory/L1 cache 570, L2 cache 460, and memory 304 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 570 enables the shared memory/L1 cache 570 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 3, are bypassed, creating a much simpler programming model. In the general purpose parallel computation configuration, the work distribution unit 325 assigns and distributes blocks of threads directly to the DPCs 420. The threads in a block execute the same program, using a unique thread ID in the calculation to ensure each thread generates unique results, using the SM 440 to execute the program and perform calculations, shared memory/L1 cache 570 to communicate between threads, and the LSU 554 to read and write global memory through the shared memory/L1 cache 570 and the memory partition unit 380. When configured for general purpose parallel computation, the SM 440 can also write commands that the scheduler unit 320 can use to launch new work on the DPCs 420.

The PPU 300 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 300 is embodied on a single semiconductor substrate. In another embodiment, the PPU 300 is included in a system-on-a-chip (SoC) along with one or more other devices such as additional PPUs 300, the memory 304, a reduced instruction set computer (RISC) CPU, a memory management unit (MMU), a digital-to-analog converter (DAC), and the like.

In an embodiment, the PPU 300 may be included on a graphics card that includes one or more memory devices. The graphics card may be configured to interface with a PCIe slot on a motherboard of a desktop computer. In yet another embodiment, the PPU 300 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5B is a conceptual diagram of a processing system 500 implemented using the PPU 300 of FIG. 3, in accordance with an embodiment. The exemplary system 565 may be configured to implement the method 110 shown in FIG. 1A and/or the method 200 shown in FIG. 2A. The processing system 500 includes a CPU 530, switch 510, and multiple PPUs 300, and respective memories 304. The NVLink 310 provides high-speed communication links between each of the PPUs 300. Although a particular number of NVLink 310 and interconnect 302 connections are illustrated in FIG. 5B, the number of connections to each PPU 300 and the CPU 530 may vary. The switch 510 interfaces between the interconnect 302 and the CPU 530. The PPUs 300, memories 304, and NVLinks 310 may be situated on a single semiconductor platform to form a parallel processing module 525. In an embodiment, the switch 510 supports two or more protocols to interface between various different connections and/or links.

In another embodiment (not shown), the NVLink 310 provides one or more high-speed communication links between each of the PPUs 300 and the CPU 530 and the switch 510 interfaces between the interconnect 302 and each of the PPUs 300. The PPUs 300, memories 304, and interconnect 302 may be situated on a single semiconductor platform to form a parallel processing module 525. In yet another embodiment (not shown), the interconnect 302 provides one or more communication links between each of the PPUs 300 and the CPU 530 and the switch 510 interfaces between each of the PPUs 300 using the NVLink 310 to provide one or more high-speed communication links between the PPUs 300. In another embodiment (not shown), the NVLink 310 provides one or more high-speed communication links between the PPUs 300 and the CPU 530 through the switch 510. In yet another embodiment (not shown), the interconnect 302 provides one or more communication links between each of the PPUs 300 directly. One or more of the NVLink 310 high-speed communication links may be implemented as a physical NVLink interconnect or either an on-chip or on-die interconnect using the same protocol as the NVLink 310.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 300 and/or memories 304 may be packaged devices. In an embodiment, the CPU 530, switch 510, and the parallel processing module 525 are situated on a single semiconductor platform.

In an embodiment, the signaling rate of each NVLink 310 is 20 to 25 Gigabits/second and each PPU 300 includes six NVLink 310 interfaces (as shown in FIG. 5B, five NVLink 310 interfaces are included for each PPU 300). Each NVLink 310 provides a data transfer rate of 25 Gigabytes/second in each direction, with six links providing 300 Gigabytes/second. The NVLinks 310 can be used exclusively for PPU-to-PPU communication as shown in FIG. 5B, or some combination of PPU-to-PPU and PPU-to-CPU, when the CPU 530 also includes one or more NVLink 310 interfaces.

In an embodiment, the NVLink 310 allows direct load/store/atomic access from the CPU 530 to each PPU's 300 memory 304. In an embodiment, the NVLink 310 supports coherency operations, allowing data read from the memories 304 to be stored in the cache hierarchy of the CPU 530, reducing cache access latency for the CPU 530. In an embodiment, the NVLink 310 includes support for Address Translation Services (ATS), allowing the PPU 300 to directly access page tables within the CPU 530. One or more of the NVLinks 310 may also be configured to operate in a low-power mode.

FIG. 5C illustrates an exemplary system 565 in which the various architecture and/or functionality of the various previous embodiments may be implemented. The exemplary system 565 may be configured to implement the method 110 shown in FIG. 1A and method 200 shown in FIG. 2A.

As shown, a system 565 is provided including at least one central processing unit 530 that is connected to a communication bus 575. The communication bus 575 may be implemented using any suitable protocol, such as PCI (Peripheral Component Interconnect), PCI-Express, AGP (Accelerated Graphics Port), HyperTransport, or any other bus or point-to-point communication protocol(s). The system 565 also includes a main memory 540. Control logic (software) and data are stored in the main memory 540 which may take the form of random access memory (RAM).

The system 565 also includes input devices 560, the parallel processing system 525, and display devices 545, e.g. a conventional CRT (cathode ray tube), LCD (liquid crystal display), LED (light emitting diode), plasma display or the like. User input may be received from the input devices 560, e.g., keyboard, mouse, touchpad, microphone, and the like. Each of the foregoing modules and/or devices may even be situated on a single semiconductor platform to form the system 565. Alternately, the various modules may also be situated separately or in various combinations of semiconductor platforms per the desires of the user.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes.

The system 565 may also include a secondary storage (not shown). The secondary storage 610 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 540 and/or the secondary storage. Such computer programs, when executed, enable the system 565 to perform various functions. The memory 540, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 565 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Machine Learning

Deep neural networks (DNNs) developed on processors, such as the PPU 300 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 300. Inferencing is less compute-intensive than training, being a latency-sensitive process where a trained neural network is applied to new inputs it has not seen before to classify images, translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 300 is a computing platform capable of delivering performance required for deep neural network-based artificial intelligence and machine learning applications.

It is noted that the techniques described herein (e.g., methods 110 and 200) may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method, comprising:
receiving a neural network trained to satisfy a loss function using a first set of hyperparameters and a first training dataset, wherein the trained neural network generates output data including visual artifacts;
receiving a second training dataset;
receiving a second set of hyperparameters, wherein a second learning parameter specified in the second set of hyperparameters limits adjustments of one or more weights used by the neural network compared with a corresponding first learning parameter in the first set of hyperparameters; and
applying the second training dataset to the neural network according to the second set of hyperparameters while adjusting the one or more weights used by the neural network to process the second training dataset to produce a first microtrained neural network.

2. The method of claim 1, wherein the first learning parameter comprises a first learning rate, and the second learning parameter comprises a second learning rate that is less than the first learning rate.

3. The method of claim 2, wherein the second learning rate is at least ten times lower than the first learning rate.

4. The method of claim 1, further comprising determining that a completion requirement has been satisfied.

5. The method of claim 4, wherein determining comprises receiving an input indication from a user interface.

6. The method of claim 1, further comprising generating and displaying a test image from a corresponding training image within the second training dataset using the first microtrained neural network, wherein the visual artifacts are reduced within the test image relative to a second test image generated by the neural network for the corresponding training image.

7. The method of claim 1, wherein the visual artifacts include geometric aliasing artifacts.

8. The method of claim 1, wherein the visual artifacts include rendering noise artifacts.

9. The method of claim 1, wherein the visual artifacts include lighting effect artifacts.

10. The method of claim 1, wherein the neural network implements a U-Net architecture with a first set of activation function weights and the first microtrained neural network implements a corresponding U-Net architecture with a second, different set of activation function weights.

11. The method of claim 1, wherein the first set of hyperparameters includes a first training iteration count and the second set of hyperparameters comprises a second training iteration count that is less than the first training iteration count.

12. The method of claim 11, wherein the second training iteration count is at least one thousand times smaller than the first training iteration count.

13. A system, comprising:
a memory circuit with programming instructions stored therein;
a parallel processing unit coupled to the memory circuit, wherein the parallel processing unit retrieves and executes the programming instructions to:
receive a neural network trained to satisfy a loss function using a first set of hyperparameters and a first training dataset, wherein the trained neural network generates output data including visual artifacts;
receive a second training dataset;
receive a second set of hyperparameters, wherein a second learning parameter specified in the second set of hyperparameters limits adjustments of one or more weights used by the neural network compared with a corresponding first learning parameter in the first set of hyperparameters; and
apply the second training dataset to the neural network according to the second set of hyperparameters while adjusting the one or more weights used by the neural network to process the second training dataset to produce a first microtrained neural network.

14. The system of claim 13, wherein the first learning parameter comprises a first learning rate, and the second learning parameter comprises a second learning rate that is less than the first learning rate that is at least ten times lower than the first learning rate.

15. The system of claim 13, wherein the visual artifacts include one or more of: geometric aliasing artifacts, rendering noise artifacts, and lighting effect artifacts.

16. The system of claim 13, wherein the first set of hyperparameters includes a first training iteration count and the second set of hyperparameters comprises a second training iteration count that is less than the first training iteration count.

17. The system of claim 13, wherein the neural network implements a U-Net architecture with a first set of activation function weights and the first microtrained neural network implements a corresponding U-Net architecture with a second, different set of activation function weights.

18. A non-transitory computer-readable media storing computer instructions for facial analysis that, when executed by one or more processors, cause the one or more processors to:
receive a neural network trained to satisfy a loss function using a first set of hyperparameters and a first training dataset, wherein the trained neural network generates output data including visual artifacts;
receive a second training dataset;
receive a second set of hyperparameters, wherein a second learning parameter specified in the second set of hyperparameters limits adjustments of one or more weights used by the neural network compared with a corresponding first learning parameter in the first set of hyperparameters; and
apply the second training dataset to the neural network according to the second set of hyperparameters while adjusting the one or more weights by the neural network used to process the second training dataset to produce a first microtrained neural network.

19. The non-transitory computer-readable media of claim 18, wherein the first learning parameter comprises a first learning rate, and the second learning parameter comprises a second learning rate that is less than the first learning rate that is at least ten times lower than the first learning rate.

20. The non-transitory computer-readable media of claim 18, wherein the first set of hyperparameters includes a first training iteration count and the second set of hyperparameters comprises a second training iteration count that is less than the first training iteration count.
